(19) United States
(12) Patent Application Publication
(10) Pub. No.: US 2012/0048081 A1
(43) Pub. Date: Mar. 1, 2012

(54) CUTTING APPARATUS AND CUTTING METHOD

(75) Inventors: Toshiharu TANAKA, Shinagawa-ku (JP); Yasuhisa Koseki, Shinagawa-ku (JP)

(73) Assignee: HIRATA CORPORATION, Tokyo (JP)

(21) Appl. No.: 13/220,278

(22) Filed: Aug. 29, 2011

(30) Foreign Application Priority Data
Sep. 1, 2010 (JP) 2010-196056

(51) Int. Cl. B26D 1/18; B26D 5/20; B26D 7/26

(52) U.S. Cl. 83/34; 83/508.2; 83/483

(57) ABSTRACT

This invention provides a cutting apparatus including a disc blade which trims a cover sheet along a linear edge of a substrate, a driving unit which rotates the disc blade, and a moving device which moves one of the driving unit and the substrate so as to relatively move the disc blade along the linear edge. This cutting apparatus further includes a pivot unit which pivots the disc blade about an axis perpendicular to a surface of the substrate for adjusting an angle between a plane which includes the linear edge and is perpendicular to the surface of the substrate and a plane formed by the disc blade, the pivot unit maintaining a pivot angle of the disc blade, and a controller which controls the moving device and the pivot unit.

### BACKGROUND OF THE INVENTION

1. Field of the Invention

The present invention relates to a technique of cutting a cover sheet which covers a substrate.

2. Description of the Related Art

As a cutting apparatus for sheet-like objects, an apparatus having the following arrangement has been provided. For example, Japanese Patent Laid-Open No. 08-229883 discloses an apparatus which cuts roll paper by moving a disc blade along a fixed blade. Japanese Patent Laid-Open No. 2004-025402 discloses an apparatus which trims a protective tape for a semiconductor wafer along the periphery of a semiconductor wafer. Japanese Patent Laid-Open No. 2007-054926 also discloses an apparatus which cuts a sheet-like member by moving a disc blade along a guide member.

In some cases, a cover sheet covers a substrate such as a glass substrate or a semiconductor wafer to protect its surface. For example, a solar cell module substrate uses a cover sheet to protect the light-receiving surface and binds a plurality of members formed in a multilayer form which constitute the substrate. A portion of the cover sheet which protrudes from the periphery of the substrate is not necessary, and hence it is necessary to cut it. For a substrate having linear edges on four sides like a rectangular substrate, in particular, it is necessary to cut a cover sheet along the linear edges without causing damage such as crack to the linear edges.

### SUMMARY OF THE INVENTION

It is an object of the present invention to cut a cover sheet along the linear edges of a substrate without damaging the edges of the substrate.

According to the present invention, it is provided a cutting apparatus comprising: a disc blade which trims a cover sheet covering a substrate along a linear edge of the substrate; a driving unit which supports the disc blade vertically with respect to a plane direction of the substrate and rotate the disc blade; a moving device which moves one of the driving unit and the substrate so as to move the disc blade along the linear edge with respect to the substrate; a pivot unit which pivots the disc blade about an axis perpendicular to a surface of the substrate for adjusting an angle between a plane which includes the linear edge and is perpendicular to the surface of the substrate and a plane formed by the disc blade, the pivot unit maintaining a pivot angle of the disc blade; and a controller which controls the moving device and the pivot unit.

Further features of the present invention will become apparent from the following description of exemplary embodiments (with reference to the attached drawings).

### BRIEF DESCRIPTION OF THE DRAWINGS

FIG. 1 is a plan view of a cutting apparatus according to an embodiment of the present invention;

FIG. 2 is a front view of the cutting apparatus;

FIG. 3 is a perspective view of a head unit;

FIG. 4 is an exploded perspective view of the main components of a cutting unit;

FIG. 5 is a sectional view of a driving unit;

FIG. 6A is an enlarged view of the blade tip portion of a disc blade, and FIG. 6B is a view for explaining how the blade tip portion cuts a cover sheet;

FIG. 7A is an enlarged view of the blade tip portion of another example of the disc blade, and FIG. 7B is a view for explaining how the blade tip portion cuts a cover sheet;

FIG. 8 is a block diagram of a controller;

FIGS. 9A and 9B are views for explaining teaching;

FIGS. 10A and 10B are views for explaining trimming operation;

FIGS. 11A and 11B are views for explaining trimming operation;

FIGS. 12A and 12B are views for explaining trimming operation;

FIG. 13 is a view for explaining trimming operation;

FIGS. 14A and 14B are views for explaining another example of trimming operation;

FIGS. 15A and 15B are views for explaining another example of trimming operation; and

FIGS. 16A and 16B are views for explaining another example of trimming operation.

### DESCRIPTION OF THE EMBODIMENTS

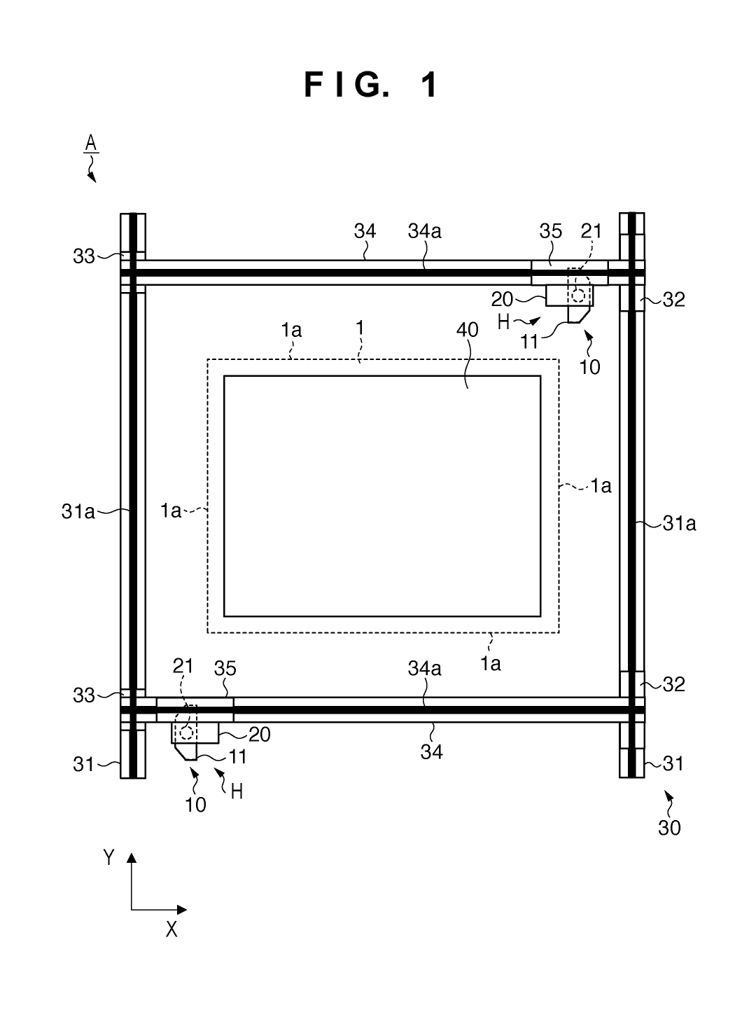

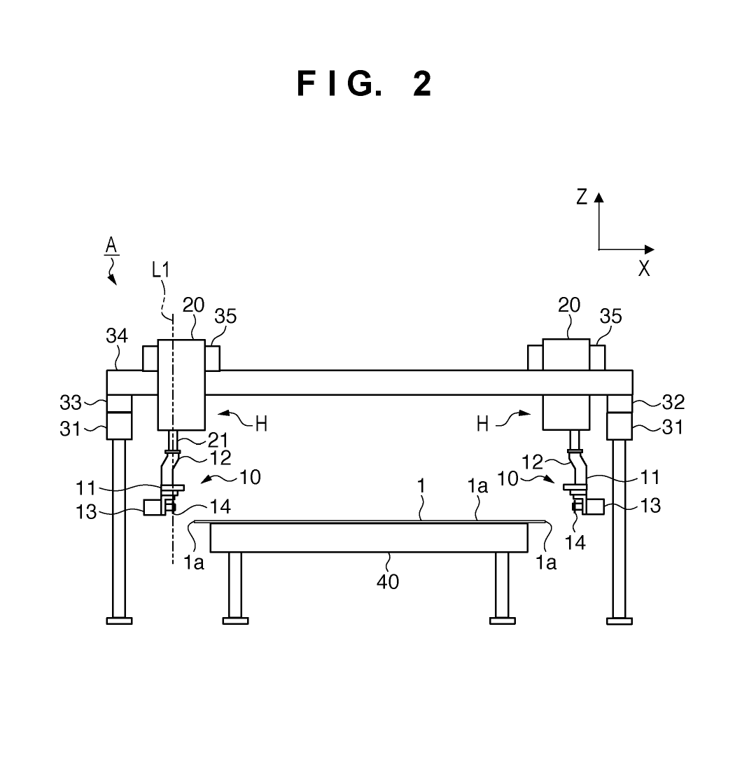

FIG. 1 is a plan view of a cutting apparatus A according to an embodiment of the present invention. FIG. 2 is a front view of the cutting apparatus A. Referring to FIGS. 1 and 2, arrows X and Y indicate two directions perpendicular to each other in a horizontal plane, and an arrow Z indicates a vertical direction. The cutting apparatus A includes head units H, a moving device 30 which moves the head units H on an X-Y plane, and a holding unit 40 which holds a substrate 1. The head units H include cutting units 10 and pivoting/lifting units 20 which move vertically and cause the cutting units 10 to pivot. These components will be described below.

<Holding Unit 40>

The holding unit 40 has an upper surface serving as a horizontal surface on which the substrate 1 is placed. The upper surface of the holding unit 40 may be provided with a fixing mechanism to releasably fix the substrate 1. This fixing mechanism includes, for example, a chucking mechanism which chucks the substrate 1. The fixing mechanism allows to a cover sheet (not shown in FIGS. 1 and 2) covering the substrate 1 to be accurately cut.

The substrate 1 is, for example, a glass plate. In this embodiment, the substrate 1 is assumed to be a rectangular substrate with four sides each of which forms a linear edge 1a. The cutting apparatus A of the embodiment trims the cover sheet along the linear edges 1a. The cutting apparatus A can be applied to not only a substrate whose contour is constituted by only the linear edges 1a like the substrate 1 but also substrates having various shapes each including a linear edge as part of the contour.

A convey mechanism (not shown) conveys and places the substrate 1 onto the holding unit 40. In this case, the substrate 1 is positioned so as to make the respective sides parallel to the X and Y directions, and is placed on the upper surface of the holding unit 40 in a horizontal posture.

<Moving Device 30>

The moving device 30 roughly includes head unit moving units (rail portions 34 and driving sliders 35) which move the head units H, moving units (rail portions 31, driving sliders 32, and driven sliders 33) which move the head unit moving units. These components will be described in detail below.

The moving device 30 includes the pair of rail portions 31 which are spaced apart from each other in the X direction and extend in the Y direction. The rail portions 31 have guide grooves 31a formed in their upper surfaces so as to extend in the Y direction. One of the rail portions 31 is provided with the two driving sliders 32 which can move on the rail portions 31 while being guided by the guide grooves 31a. The other rail portion 31 is provided with the two driven sliders 33 which can move on the rail portions 31 while being guided by the guide grooves 31a. The driving sliders 32 and the driven sliders 33 are paired. In this embodiment, two pairs of the driving sliders 32 and the driven sliders 33 are provided.

Each driving slider 32 includes an independent driving source and independently travels by itself on the rail portion 31. As a mechanism for making the driving slider 32 travel by itself, for example, a ball screw mechanism can be used, which includes a ball screw provided on the rail portion 31 and a ball nut which threadably engages with the ball screw. Each driving slider 32 can include a ball nut and a rotation driving unit (for example, a hollow motor) which rotatably holds the ball nut and rotates it. Each driven slider 33 has no mechanism for making it travel by itself.

The rail portion 34 is laid across the driving slider 32 and driven slider 33 of each pair. The rail portion 34 extends in the X direction and translates in the Y direction as the driving slider 32 moves in the Y direction. The rail portion 34 has a guide groove 34a formed in its upper surface so as to extend in the X direction. Each rail portion 34 is provided with the driving slider 35 which can move on the rail portion 34 while being guided by the guide groove 34a. The driving slider 35 travels by itself on the rail portion 34 by using the same mechanism as that of the driving slider 32 described above.

The pivoting/lifting unit 20 is fixed to each driving slider 35. Moving the driving slider 35 can move the pivoting/lifting unit 20 and the cutting unit 10 in the X direction.

In this manner, this embodiment can move the head units H on an X-Y plane. The embodiment is configured to move the cutting units 10 with respect to the substrate 1. However, it is possible to move the substrate 1. That is, it is possible to move either the cutting units 10 or the substrate 1 as long as disc blades 14 can move with respect to the substrate 1 along the linear edges 1a.

Note that the moving device 30 includes sensor units (not shown) for detecting the positions of the cutting units 10 in the X-Y direction. Such sensors include, for example, sensor units for detecting the positions of the driving sliders 32 and 35. More specifically, if the driving sources for the driving sliders 32 and 35 are motors, such sensors include sensors (for example, encoders) which detect the amounts of rotation of the motors.

<Pivoting/Lifting Unit 20>

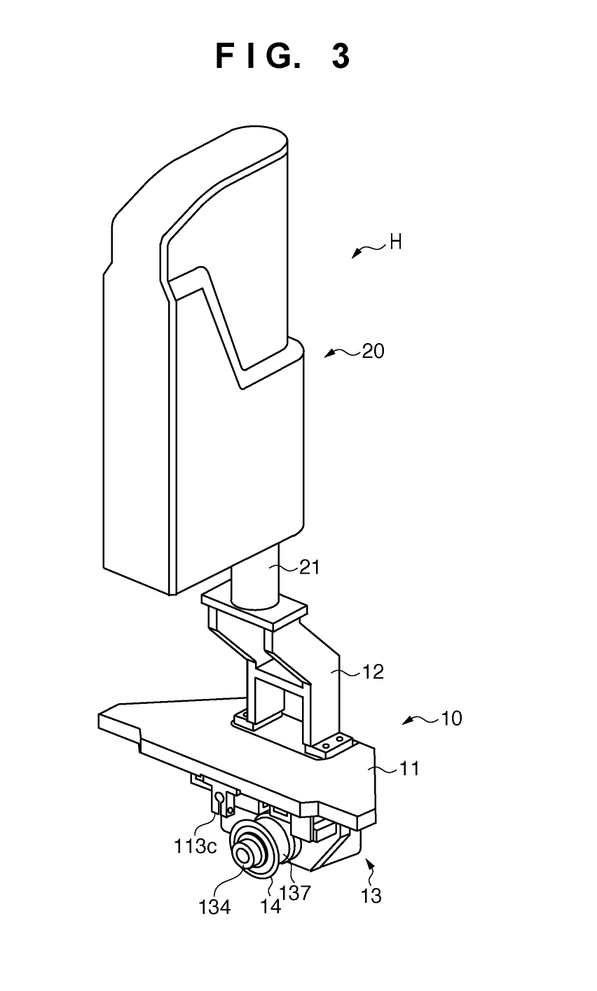

The pivoting/lifting unit 20 will be described with reference to FIGS. 2 and 3. FIG. 3 is a perspective view of the cutting unit 10 and pivoting/lifting unit 20. The pivoting/lifting unit 20 includes a shaft body 21 and a mechanism (not shown) which allows the shaft body 21 to rotate around its axis (a broken line L1 in FIG. 2) and moves the shaft body 21 up and down. The shaft body 21 has its axis in the Z direction.

In this embodiment, the cutting unit 10 is coupled to the shaft body 21 so that rotating the shaft body 21 can make the cutting unit 10 pivot about the pivot center axis (the broken line L1 in FIG. 2) in the Z direction and maintain its pivot angle, and moving the shaft body 21 up and down can move the cutting unit 10 up and down in the Z direction.

Making the cutting unit 10 pivot and maintaining its pivot angle can adjust the angle (intersection angle) between a plane (a vertical plane in the Z direction in this embodiment) perpendicular to the substrate surface of the substrate 1 including the linear edges 1a to be subjected to trimming and a plane (a vertical plane in the Z direction in the embodiment) formed by the disc blade 14. Adjusting and maintaining this angle can make the disc blade 14 abut against the edges of the substrate 1 at a preferred angle, thereby preventing the edges of the substrate 1 from being damaged at the time of cutting the cover sheet.

In addition, moving the cutting unit 10 up and down can adjust the cutting blade position (height position) of a blade tip 14b formed on the peripheral surface of the disc blade 14 (to be described later) with respect to a plane (a vertical plane in the Z direction in this embodiment) perpendicular to the substrate surface of the substrate 1 which includes the linear edge 1a subjected to trimming and a plane (a vertical plane in the Z direction in the embodiment) formed on the disc blade 14.

It is possible to adjust the direction and cutting blade position of the disc blade 14 in this manner. This makes it possible to cut a cover sheet along the linear edge 1a at an optimal inclination and cutting blade position in accordance with the type of cover sheet.

A known mechanism can be used as a mechanism which rotates and moves the shaft body 21 up and down. For example, a mechanism for rotating the shaft body 21 includes a combination of a driving source such as a motor and a mechanism such as a gear mechanism or a belt mechanism. As a mechanism for maintaining the rotational angle of the shaft body 21, if, for example, a servo motor is used as a driving source, the electromagnetic lock function of the servo motor can be used. Alternatively, it is possible to separately provide a lock mechanism for releasably restricting the rotation of the shaft body 21. A mechanism for moving the shaft body 21 up and down can include a combination of a driving source such as a motor and a mechanism such as a rack-pinion mechanism.

Note that each pivoting/lifting unit 20 includes a sensor unit (not shown) for detecting the pivot angle (pivot position) and Z-direction position of the cutting unit 10. If the driving source which rotates and moves the shaft body 21 up and down is a motor, such a sensor include a sensor (for example, an encoder) which detects the amount of rotation of the motor.

<Cutting Unit 10>

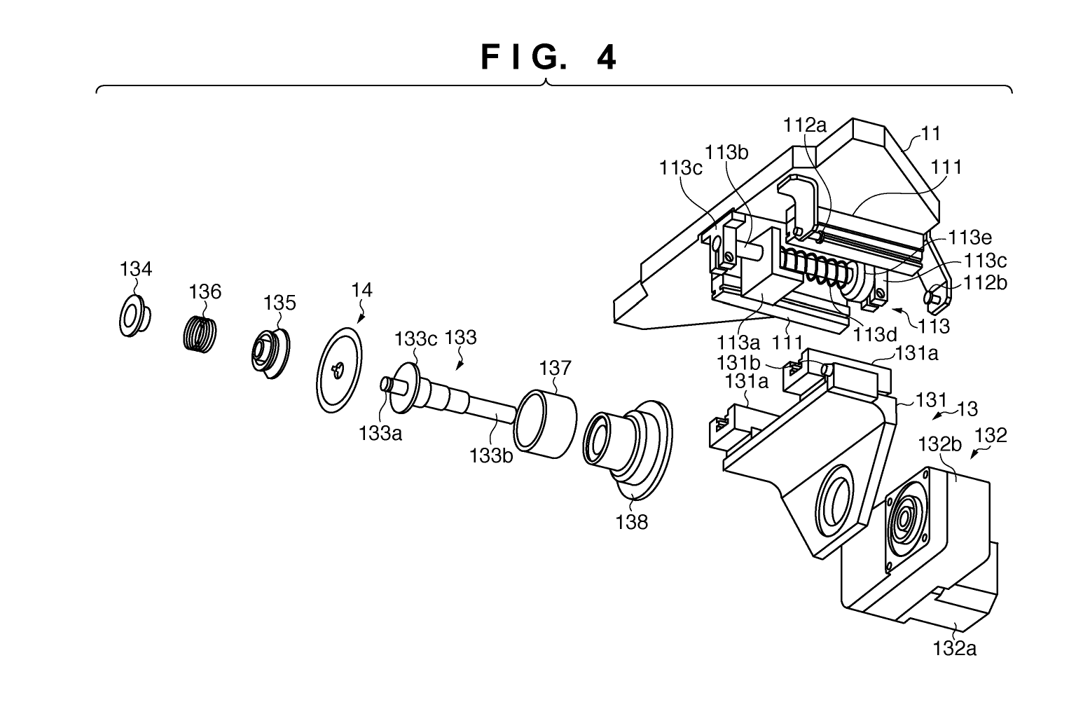

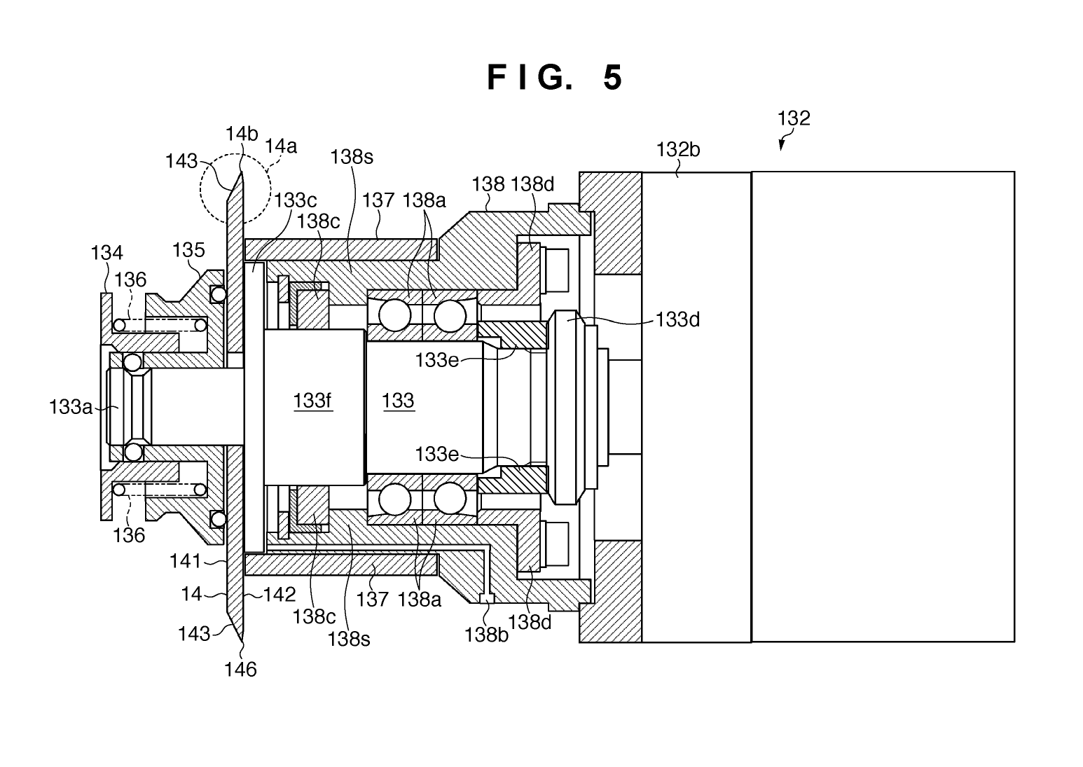

The cutting unit 10 will be described with reference to FIGS. 3 to 5. FIG. 4 is an exploded perspective view of the main components of the cutting unit 10. FIG. 5 is a sectional view of a driving unit 13. The cutting unit 10 includes a plate-like main support portion 11, a coupling portion 12 which couples the shaft body 21 of the pivoting/lifting unit 20 to the main support portion 11, and the driving unit 13 which supports the disc blade 14 vertically with respect to a plane direction of the substrate 1 (a horizontal direction in this embodiment) and rotates the disc blade 14.

The driving unit 13 includes a support portion (slider) 131 having an almost L-shaped cross-section which has a vertical portion and a horizontal portion. A driving unit 132 is attached to the rear surface side (opposite to the side on which the disc blade 14 is located) of the vertical portion of the support portion 131. The driving unit 132 includes a motor 132a as a driving source and a reduction gear 132b which decelerates the output of the motor 132a. A rear end portion 133b of a rotating shaft body 133 of the disc blade 14 is connected to the reduction gear 132b. As the motor 132a rotates, the rotating shaft body 133 rotates about its axis.

The rotating shaft body 133 has an attachment portion 133a, on its distal end portion, to which the disc blade 14 is attached. A collar-like disc blade abutment portion 133c is formed near the attachment portion 133a. The disc blade 14 with a key groove serving as a detent, a press member 135, and a stop member 134 are sequentially fitted on the attachment portion 133a. The stop member 134 is threadably engaged with the distal end of the attachment portion 133a. An elastic member 136 is inserted between the stop member 134 and the press member 135. In this embodiment, the elastic member 136 is a coil spring. The elastic member 136 biases the press member 135 toward the disc blade 14 to clamp the disc blade 14 between the disc blade abutment portion 133c and the press member 135, thereby suppressing the rotational vibration of the disc blade 14.

The rotating shaft body 133 extends in the horizontal direction. Attaching the disc blade 14 to the rotating shaft body 133 makes the plane formed by the disc blade 14 become perpendicular to a horizontal plane. The coupling position of the cutting unit 10 with respect to the pivoting/lifting unit 20 is adjusted such that the pivot center axis (the line L1 in FIG. 2: vertical direction) of the pivoting/lifting unit 20 is included in a plane parallel to a plane including the disc blade 14 (a vertical plane in this embodiment). It is possible to perform this adjustment by adjusting at least the shape of the coupling portion 12 or the coupling position between the coupling portion 12 and the main support portion 11. Making adjustment in this manner can position the disc blade 14 immediately below the pivot center axis of the pivoting/lifting unit 20. This leads to an advantage that when making the cutting unit 10 pivot by using the pivoting/lifting unit 20, it is easy to adjust the inclination of the plane formed by the disc blade 14 with respect to the linear edge 1a of the substrate 1.

The rotating shaft body 133 is axially supported by a ball bearing 138a. The ball bearing 138a is fitted in an inner peripheral wall of a tubular support member 138 on the rear end side. A fixing member 138d fastened with bolts prevents removal of the ball bearing 138a. A fixing ring 133d is screwed to the rear end portion side of the rotating shaft body 133. A fixing tubular body 133e is provided between the fixing ring 133d and the ball bearing 138a. The position of the fixing ring 133d is fixed in the axial direction of the rotating shaft body 133 by threadably engaging the fixing ring 133d with the rotating shaft body 133 and threading the fixing ring 133d toward the distal end side. With this structure, when the elastic member 136 biases in the above manner, the rotating shaft body 133 is pulled to the distal end side to make the fixing ring 133d abut against the fixing tubular body 133e, thus making the fixing tubular body 133e abut against the ball bearing 138a. This relatively positions the rotating shaft body 133 in the axial direction of the support member 138.

A seal portion 138c is formed inside the distal end side of a small-diameter portion 138s formed on the support member 138. The inner circumferential surface of the seal portion 138c is in tight contact with the outer circumferential surface of a first diameter portion 133f continuously formed from the collar portion 133c of the rotating shaft body 133 to the rear end portion side. The seal portion 138c prevents cutting debris and the like of the cover sheet from entering the ball bearing 138a. In addition, an air path 138b is formed in the support member 138 so as to communicate with the gap between the disc blade abutment portion 133c and the support member 138. An air supply unit (not shown) supplies compressed air into the air path 138b. This compressed air is supplied to the space (gap) surrounded by the rotating shaft body 133, the support member 138, and the seal portion 138c. This increases the air pressure in the gap to generate an air current from the gap to the outside (atmospheric side), thereby further preventing the cutting debris and the like of the cover sheet from entering the ball bearing 138a.

A tubular body 137 is placed near the surface (rear surface) of the disc blade 14 on the rear end portion side with the disc blade 14 being a boundary, and surrounds the outer circumferential surface of the disc blade abutment portion 133c of the rotating shaft body 133. The tubular body 137 is free-rotatably fitted on the small-diameter portion of the outer circumferential surface of the distal end portion of the support member 138. The surface of the disc blade 14 on the rear end side and the stepped portion of the small-diameter portion formed on the outer circumferential portion of the distal end portion of the support member 138 define the movement of the rotating shaft body 133 of the tubular body 137 in the axis direction. A portion cut from the cover sheet by the disc blade 14 may tangle around the rotating shaft body 133 in the form of a belt. In this embodiment, since the tubular body 137 is free-rotatably provided on the rear surface portion of the disc blade 14, when a cut portion comes into contact with (rides on) the tubular body 137, the tubular body 137 freely rotates. This can prevent the cut portion from tangling around the tubular body 137.

The retracting mechanism of the driving unit 13 will be described next with reference to FIG. 4. A pair of slide members 131a are fixed on the upper surface of the horizontal portion of the support portion 131. A pair of rail members 111 which guide the slide members 131a are fixed on the lower surface of the main support portion 11. The rail members 111 and the slide members 131a extend in the rotation axis line direction (the axis direction of the rotating shaft body 133) of the disc blade 14. The driving unit 13 is supported on the main support portion 11 through the support portion 131 and is guided by the rail members 111 to retractably move in the rotation axis line direction of the disc blade 14.

The main support portion 11 is provided with stopper portions 112a and 112b. The stopper portion 112a abuts against a stopper portion 131b provided on the support portion 131, and the stopper portion 112b abuts against the rear surface of the support portion 131, thereby restricting the moving range of the driving unit 13, that is, the disc blade 14.

The lower surface of the main support portion 11 is provided with a biasing portion 113 which always biases the driving unit 13 in the direction to approach the substrate 1. The biasing portion 113 includes a transfer member 113a, a support shaft 113b, support portions 113c, an elastic member 113d, and a reception member 113e. The support shaft 113b extends parallel to the rail members 111. The two end portions of the support shaft 113b are supported by the support portions 113c. The transfer member 113a is an L-shaped member having a hole through which the support shaft 113b extends, and can move while being guided by the support shaft 113b. The support portion 131 of the driving unit 13 is coupled to the lower portion of the transfer member 113a.

The support shaft 113b extends through the reception member 113e. The elastic member 113d is interposed between the transfer member 113a and the reception member 113e while the support shaft 113b extends through the elastic member 113d. The elastic member 113d is a coil spring in this embodiment, which is a compression coil exerting a biasing force in the direction to separate the transfer member 113a and the reception member 113e from each other. The biasing force of the elastic member 113d is transferred to the support portion 131 via the transfer member 113a.

The elastic member 113d always biases the driving unit 13 (disc blade 14) coupled to the transfer member 113a in the direction to approach the substrate 1. This can make the disc blade 14 stably abut against the linear edge 1a of the substrate 1 at the time of cutting the cover sheet, thereby implementing smooth cutting of the cover sheet. It is also possible to cut the cover sheet while absorbing, if any, the difference between a predetermined cutting position and an actually positioned cutting position on the substrate as long as the difference falls within the biasing stroke range of the elastic member 113d. When the apparatus starts cutting the cover sheet from a midway position on the linear edge 1a of the substrate 1, even if the disc blade 14 abuts against the linear edge 1a, the disc blade 14 is pressed in a direction opposite to the direction to approach the substrate 1, and the elastic member 113d deflects to absorb the shock produced when the disc blade 14 abuts against the linear edge 1a.

<Disc Blade 14>

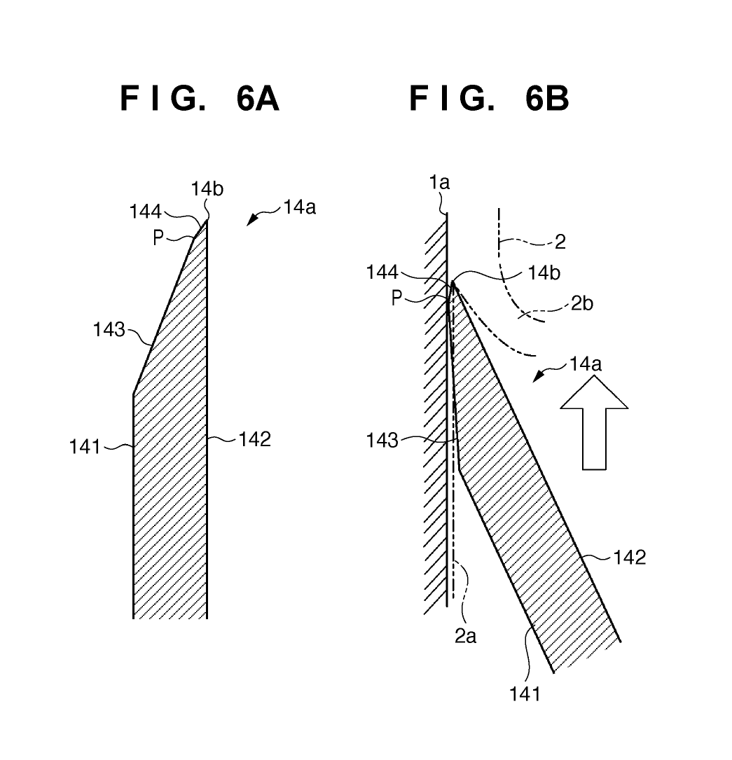

The arrangement of a blade tip portion 14a (the portion indicated by the broken line circle in FIG. 5) of the disc blade 14 will be described with reference to FIGS. 6A and 6B. FIG. 6A is an enlarged view of the blade tip portion 14a of the disc blade 14. FIG. 6B is a view for explaining how the blade tip portion 14a cuts a cover sheet 2. The disc blade 14 includes surfaces 141 and 142 which are parallel to each other and perpendicular to the rotation axis line. The surface 141 is a side surface located on the same side as that of the linear edge 1a subjected to trimming at the time of cutting the cover sheet 2. The blade tip 14b is located on the surface 142. The side surface on the surface 141 side is constituted by the surface 141 and surfaces 143 and 144 constituting the blade tip portion 14a. The surface 144 is formed as a surface intersecting the surface 142 at an acute angle at the blade tip 14b. The surface 143 is formed as a surface intersecting the surface 142 at an acuter angle (further inclining toward the rotation center side of the disc blade 14) than the surface 144. That is, the surfaces 144 and 143 are continuously formed as downward inclined surfaces with different inclinations with respect to the blade tip 14b of the surface 142.

At the time of cutting the cover sheet 2, when the blade tip 14b abuts against the linear edge 1a, the blade tip 14b may damage the linear edge 1a and tend to wear. In this embodiment, therefore, an cross point P formed by the surfaces 143 and 144 is made to abut against the linear edge 1a to cut the cover sheet 2. This can further prevent the edges of the substrate 1 from being damaged.

FIG. 6B shows a state in which a portion of the cover sheet 2 which protrudes from the linear edge 1a is being cut. A portion of the cover sheet 2 which protrudes from the linear edge 1a is cut by making the cross point P abut against the linear edge 1a and moving the cross point P along the linear edge 1a while rotating the disc blade 14. With this cutting operation, the cover sheet 2 is separated into a residual portion 2a left on the substrate 1 side and a cut portion 2b. The residual portion 2a corresponds to the gap between the blade tip 14b and the linear edge 1a, and is preferably minimized (close to the edge of the substrate).

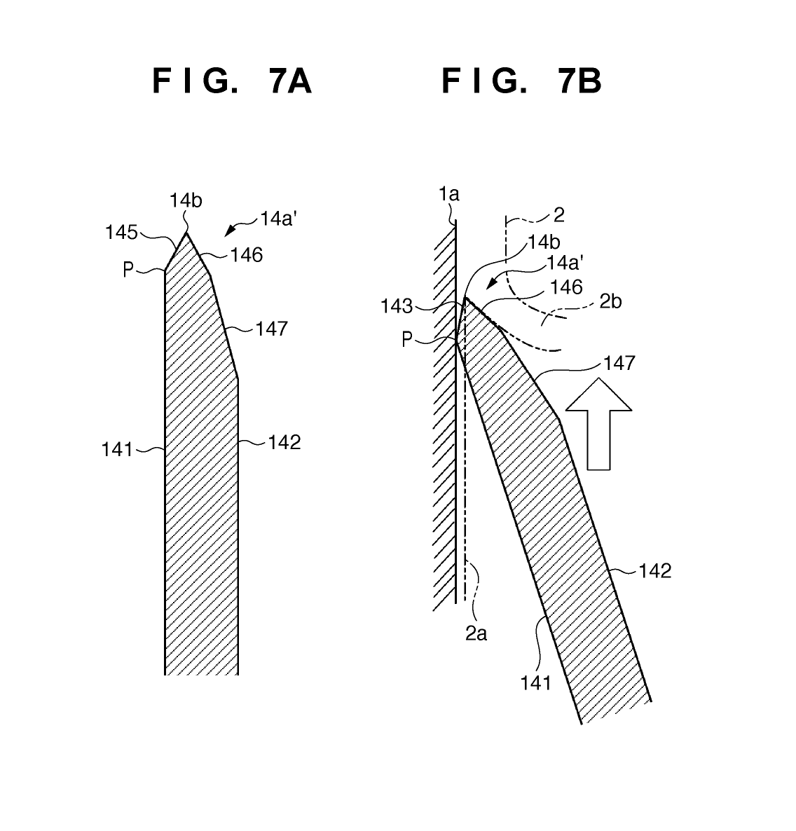

FIG. 7A is an enlarged view of a blade tip portion 14a′ of another example of the disc blade 14. FIG. 7B is a view for explaining how the blade tip portion 14a′ cuts the cover sheet 2. In the case shown in FIG. 7B, the surface 141 and a surface 145 formed from the blade tip 14b constitute a side surface located on the same side as that of the linear edge 1a subjected to trimming at the time of cutting. An cross point P between the surface 145 and the surface 141 abuts against the linear edge 1a. The surface 145 is formed to extend from the blade tip 14b to the surface 141.

A side surface located on the opposite side to the linear edge 1a at the time of cutting is constituted by a surface 146 formed from the blade tip 14b, a surface 147 which inclines toward the rotation center of the disc blade 14 with respect to the surface 146 and is continuous with the surface 146, and the surface 142. The surfaces 146 and 147 are continuously formed as downward inclined surfaces with different inclinations. The surfaces 141 and 142 are parallel to each other and perpendicular to the rotation axis line.

FIG. 7B shows a state in which a portion of the cover sheet 2 which protrudes from the linear edge 1a is being cut. A portion of the cover sheet 2 which protrudes from the linear edge 1a is cut by making the cross point P abut against the linear edge 1a and moving the cross point P along the linear edge 1a (in the direction indicated by the arrow) while rotating the disc blade 14. With this cutting operation, the cover sheet 2 is separated into a residual portion 2a left on the substrate 1 side and a cut portion 2b. In this case, the cut portion 2b is guided by the surfaces 146 and 147 to the outside in the radial direction instead of the rotation center side of the disc blade 14.

<Controller>

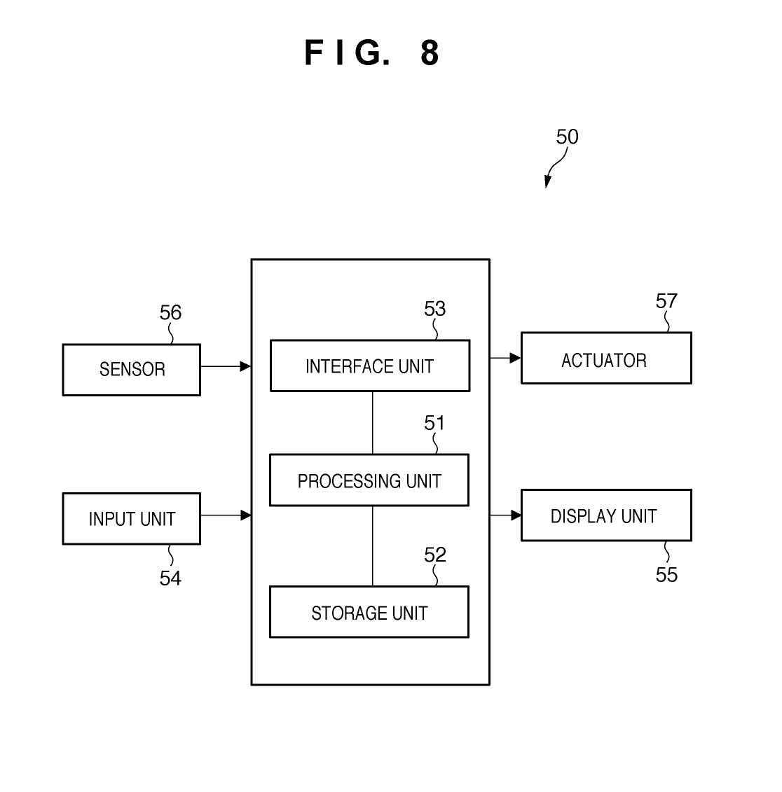

A controller 50 which controls the cutting apparatus A will be described next. FIG. 8 is a block diagram of the controller 50. The controller 50 includes a processing unit 51 such as a CPU, a storage unit 52 such as a RAM, ROM, or hard disk, and an interface unit 53 which interfaces the processing unit 51 with an external device.

The processing unit 51 executes programs stored in the storage unit 52 and controls various types of actuators 57 based on the detection results obtained by various types of sensors 56. The various types of sensors 56 include sensors which detect the positions of the cutting units 10. The various types of actuators 57 include the motors 132a. An input unit 54 includes a keyboard and a mouse which accept instructions from an operator. A display unit 55 is an image display device which displays various kinds of information.

<Example of Operation>

Trimming operation by the cutting apparatus A for the cover sheet 2 will be described next. In this embodiment, two cutting units are in charge of the opposing linear edges 1a of the substrate 1, respectively, and trim the cover sheet 2 with respect to the four sides of the substrate 1. This embodiment is configured to cut the cover sheet 2 by making the cross point P between the surfaces 143 and 144 abut against the linear edge 1a, as described with reference to FIG. 6. Importance is therefore placed on the direction of the disc blade 14 with respect to the linear edge 1a. The direction of the disc blade 14 (the intersection angle between a vertical plane including the linear edge 1a and the disc blade 14) is adjusted by the pivot angle (pivot amount) of the cutting unit 10 set by the pivoting/lifting unit 20, which is preferably set to an optimal value in advance. This embodiment is configured to store, in the storage unit 52 in advance by so-called teaching, the pivot angle (pivot amount) of the cutting unit 10 at the time of cutting and the data of a cutting start position corresponding to the size of the substrate 1.

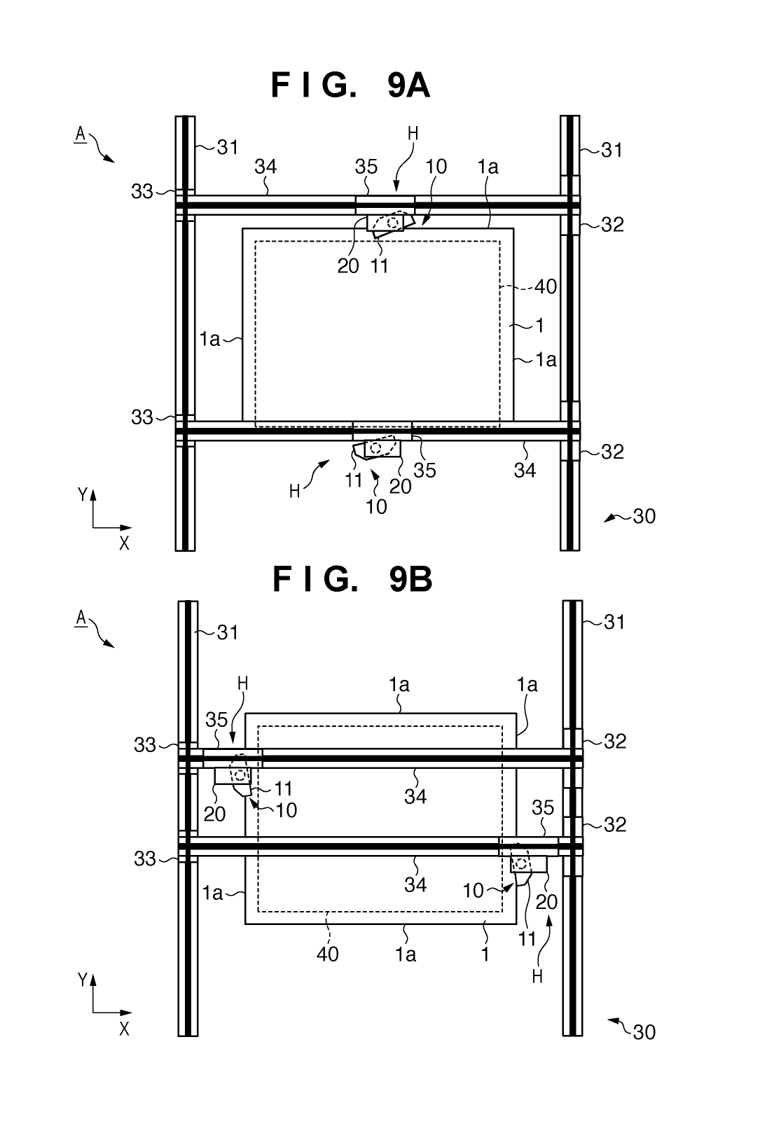

FIGS. 9A and 9B are views for explaining teaching operation. As shown in FIGS. 9A and 9B, the holding unit 40 holds a sample substrate 1 as a reference. As shown in FIG. 9A, the two cutting units 10 are approximately located at the cutting positions for the first pair of opposing linear edges 1a. The operator then manually pivot or move the cutting units 10 to locate them at the optimal cutting positions. The controller 50 then obtains optimal cutting positions (reference cutting positions) by performing sample cutting operation (reference cutting operation) upon matching the positions (in the Y and Z directions) of the respective cutting units 10 and pivot amounts with the substrate and cover sheet to be cut, and stores the resultant data in the storage unit 52. Subsequently, as shown in FIG. 9B, the controller 50 performs the same processing for the second pair of opposing linear edges 1a, detects the positions (in the X and Z directions) and pivot angles (pivot amounts) of the respective cutting units 10 at the optimal cutting positions (reference cutting positions) by using sensors, and stores the resultant data in the storage unit 52. Alternatively, it is possible to obtain optimal cutting positions (reference cutting positions) by actually performing cutting operation for a substrate and a sample substrate as a reference for a cover sheet. With the above operation, the controller 50 completes setting of the pivot angles (pivot amounts) and positions of the cutting units 10 at the time of cutting by teach processing.

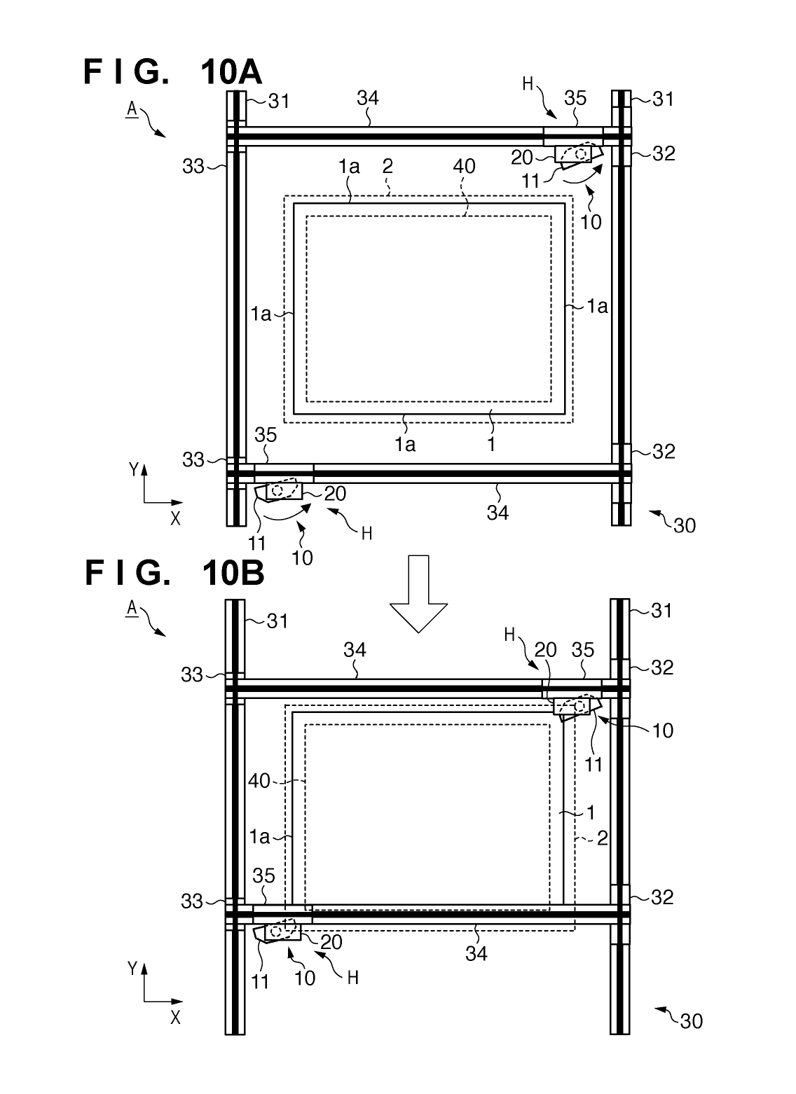

FIGS. 10A to 13 are views for explaining actual trimming operation. Assume first a case in which portions of the cover sheet 2 which protrude from the opposing linear edges 1a spaced apart from each other in the Y direction are to be trimmed. First of all, of the two pairs of linear edges 1a, the first pair of linear edges 1a are trimmed, and then the second pair of linear edges 1a adjacent to the first pair of linear edges 1a are trimmed.

As shown in FIG. 10A, while the two cutting units 10 are spaced apart from the substrate 1, each cutting unit 10 is made to pivot to the pivot angle (by the pivot amount) set by teaching in FIG. 9A. The apparatus then starts rotating the disc blades 14, and moves the cutting units 10 in the X, Y, and Z directions to the cutting start positions as shown in FIG. 10B, thereby starting cutting the cover sheet 2. The positions in the Y and Z directions at this time are based on the positions set by teaching in FIG. 9A. The two cutting units 10 are spaced apart from each other in the X direction.

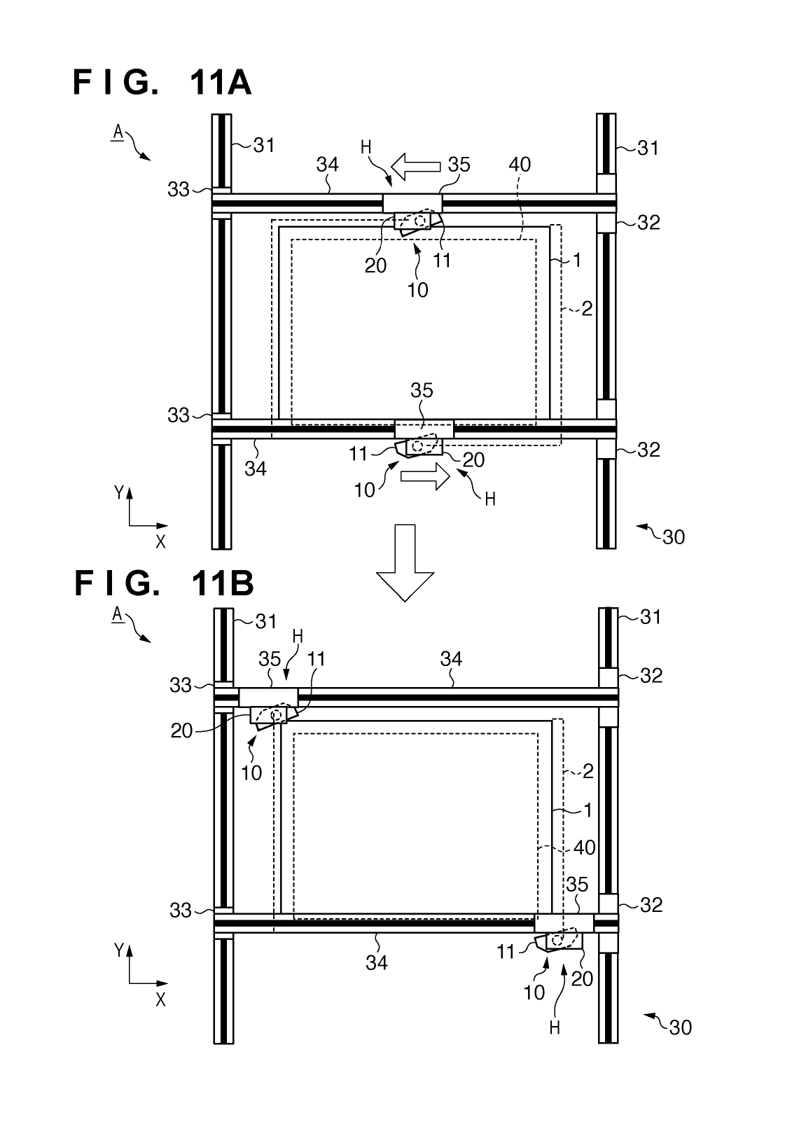

Subsequently, as shown in FIG. 11A, the apparatus cuts the cover sheet 2 along the linear edges 1a by using the disc blades 14 while moving the two cutting units 10 in the opposite directions in the X direction. Since it is possible to simultaneously trim the cover sheet 2 along two sides of the substrate 1, the operation efficiency improves.

As shown in FIG. 11B, when the cutting units 10 reach cutting end positions, the apparatus then starts trimming the second pair of linear edges 1a. For this purpose, the apparatus temporarily separates the respective cutting units 10 from the substrate 1.

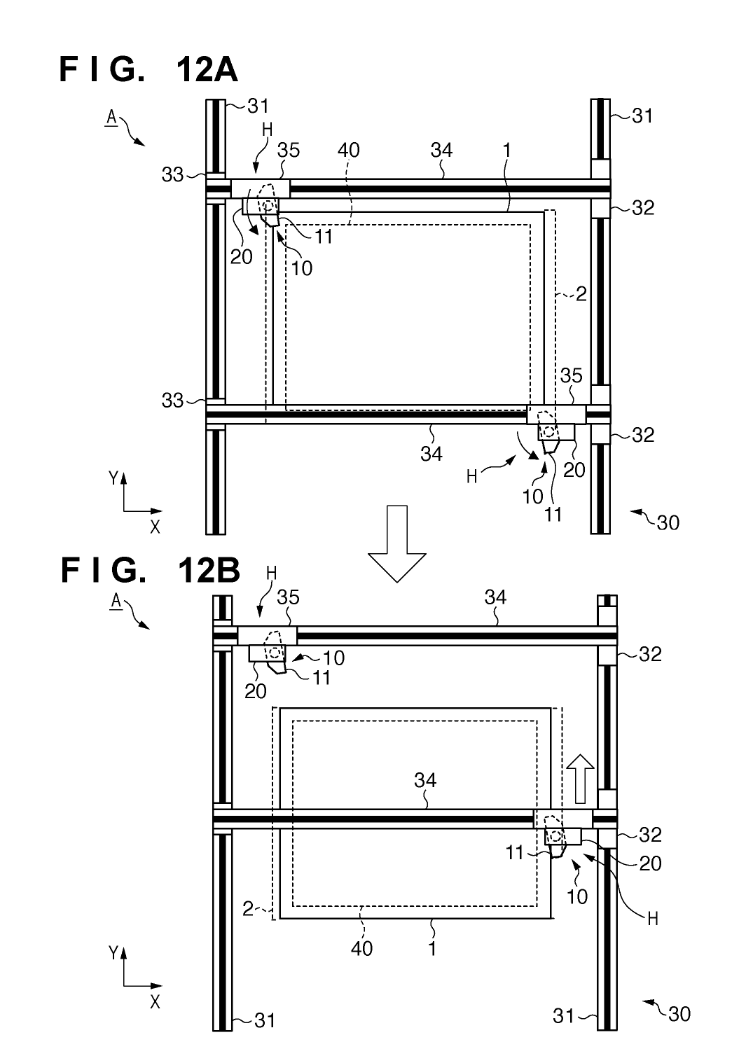

Subsequently, as shown in FIG. 12A, the apparatus rotates each cutting unit 10 by the pivot amount set by teaching in FIG. 9B to move the cutting unit 10 to the cutting start position, thus starting cutting the cover sheet. When, however, the apparatus is to trim portions of the cover sheet 2 which protrude from the opposing linear edges 1a spaced apart from each other in the X direction, the sheet is trimmed on one side at a time to prevent the two driving sliders 32 from interfering with each other.

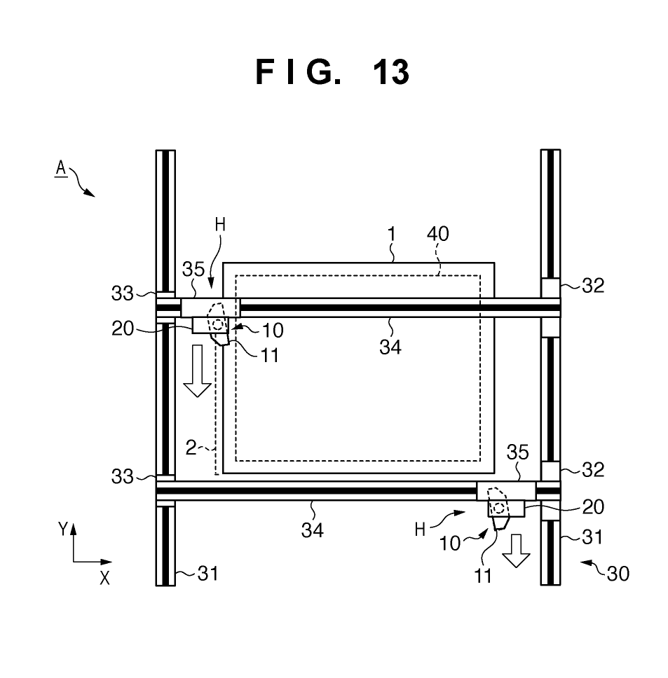

Referring to FIG. 12B, the apparatus trims a portion of the cover sheet 2 which protrudes from the linear edge 1a on the right side in FIG. 12B by moving one cutting unit 10 in the Y direction while making the other cutting unit 10 wait at a position spaced apart from the substrate 1. Upon completing trimming of a portion of the cover sheet 2 which protrudes from the right linear edge 1a, the apparatus moves the other cutting unit 10 in the Y direction to trim a portion of the cover sheet 2 which protrudes from the left linear edge 1a, as shown in FIG. 13. At this time, one cutting unit 10 which has trimmed the portion of the cover sheet 2 which protrudes from the right linear edge 1a is moved in the Y direction, while being spaced apart from the substrate 1, so as to prevent the two driving sliders 32 from interfering each other.

When completing trimming of the portion of the cover sheet 2 which protrudes from the left linear edge 1a, the apparatus completes trimming operation corresponding to one unit of operation. Thereafter, the apparatus repeatedly performs similar trimming operation for other substrates 1. Obviously, the apparatus is required to perform teaching processing only once for the substrates 1 having the same size and needs not perform teaching processing for each substrate 1. In addition, if one cutting unit 10 fails, it is possible to make the other cutting unit 10 cut all the four sides. This makes it possible to continue cutting processing.

<Other Operation Examples>

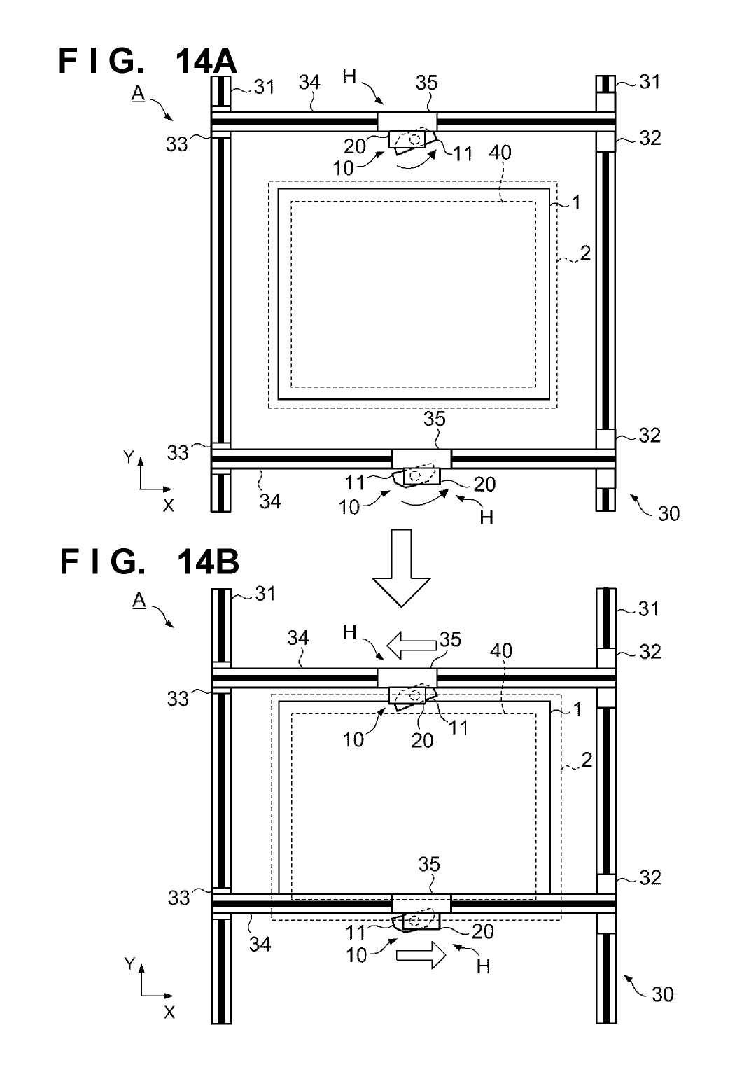

In the above operation example, each cutting start position is set at an end portion of the linear edge 1a. However, a cutting start position may be set on a midway portion (for example, a middle portion) of the linear edge 1a. FIGS. 14A to 16B show a case in which a cutting start position is set on a midway portion of the linear edge 1a.

First of all, as shown in FIG. 14A, while the two cutting units 10 are spaced apart from the substrate 1, the apparatus makes each cutting unit 10 pivot to the pivot angle (by the pivot amount) set by teaching or the like. Subsequently, the apparatus starts rotating the disc blades 14, and moves the cutting units 10 in the X, Y, and Z directions to cutting start positions on midway portions (on middle portions in the case shown n FIG. 14B) of the linear edges 1a, thereby starting cutting the cover sheet 2. It is possible to simultaneously move the two cutting units 10 in the same direction or opposite directions in the X direction. In this embodiment, the apparatus moves the cutting units in opposite directions (the directions to separate the cutting units from each other).

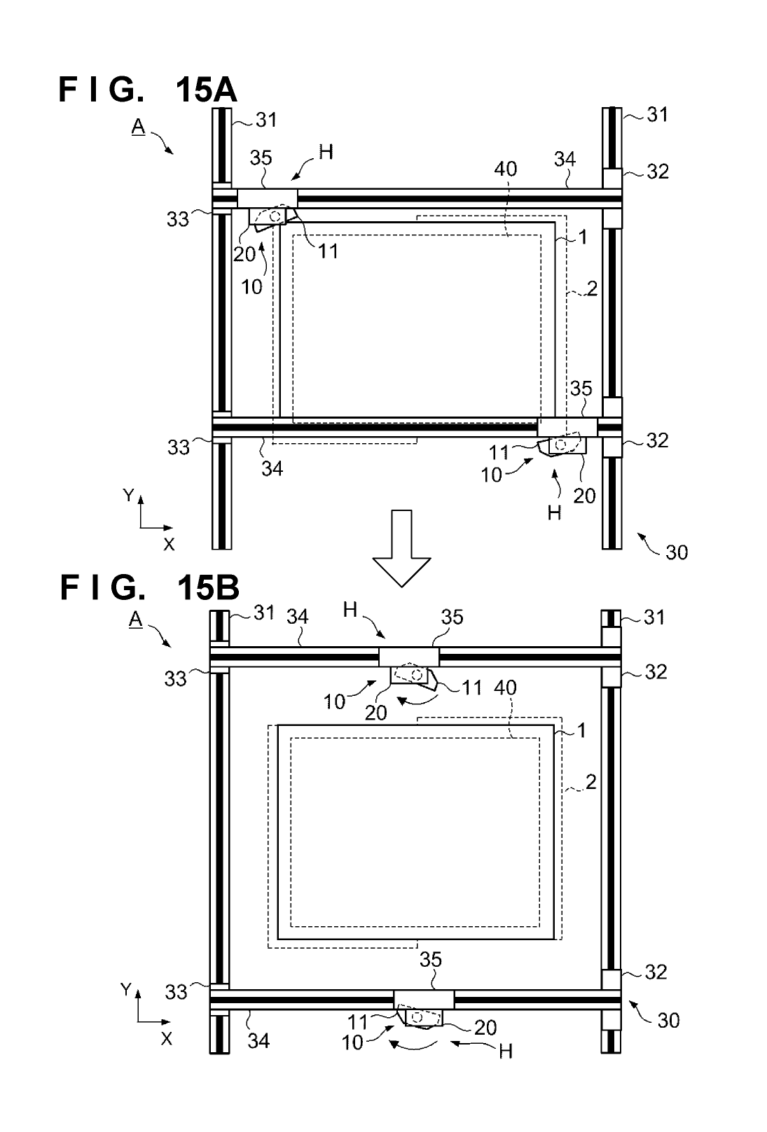

FIG. 15A shows a state in which the apparatus has cut the cover sheet 2 by moving each cutting unit 10 from the midway portion to one end portion of the linear edge 1a (first partial cutting process).

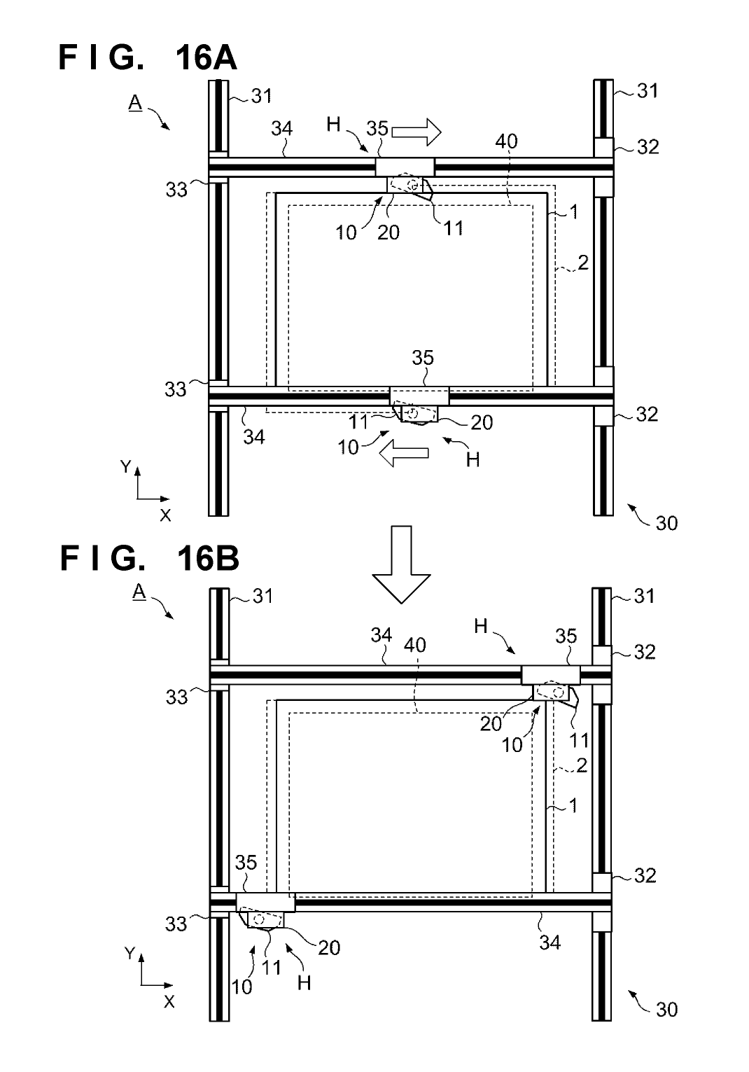

The apparatus then moves the cutting units 10 to the midway portions of the linear edges 1a. FIG. 15B shows a state in which the cutting units 10 are being moved. In this embodiment, the apparatus moves the two cutting units 10 in the directions to be spaced apart from the substrate 1 in the Y direction. The apparatus then makes each cutting unit 10 pivot to the pivot angle (by the pivot amount) set by teaching or the like. Subsequently, the apparatus moves each cutting unit 10 to a midway portion (cutting start position) of the linear edge 1a. Thereafter, as shown in FIGS. 16A and 16B, the apparatus moves the cutting unit 10 in a direction opposite to the cutting direction in the first partial cutting process, that is, to the other end portion of the linear edge 1a, thereby cutting the remaining portions of the cover sheet 2 (second partial cutting process).

In this manner, the apparatus can trim the cover sheet 2 concerning one linear edge 1a in two steps. In this operation example, the angle of the disc blade 14 is set in the above manner in the first and second partial cutting processes. In this embodiment, even when cutting the cover sheet 2 from midway portions, the pivoting/lifting units 20 can adjust and maintain the angles of the disc blades 14.

This makes it possible to suitably cut a cover sheet. It is possible to apply the method of setting each cutting start position on a midway portion of the linear edge 1a to only the first pair of linear edges 1a and then cut the second pair of linear edges 1a from end portions of the linear edges 1a. Alternatively, it is possible to apply this method to both the first pair of linear edges 1a and the second pair of linear edges 1a.

When starting cutting from a midway portion of the linear edge 1a in this manner, the positioning accuracy of the disc blade 14 for a cutting start position can be lower than that when starting cutting from an end portion. When starting cutting from an end portion of the linear edge 1a, since a cutting start position is at a corner portion of the substrate 1, it is necessary to prevent the disc blade 14 from colliding with the linear edge 1a adjacent to the linear edge 1a subjected to trimming and damaging the corner portion. When starting cutting from a midway portion of the linear edge 1a, such a problem does not arise. Therefore, the positioning accuracy need not be high.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-196056, filed Sep. 1, 2010, which is hereby incorporated by reference herein in its entirety.

What is claimed is:

1. A cutting apparatus comprising:
a disc blade which trims a cover sheet covering a substrate along a linear edge of the substrate;
a driving unit which supports said disc blade vertically with respect to a plane direction of the substrate and rotate said disc blade;
a moving device which moves one of said driving unit and the substrate so as to move said disc blade along the linear edge with respect to the substrate;
a pivot unit which pivots said disc blade about an axis perpendicular to a surface of the substrate for adjusting an angle between a plane which includes the linear edge and is perpendicular to the surface of the substrate and a plane formed by said disc blade, said pivot unit maintaining a pivot angle of said disc blade; and
a controller which controls said moving device and said pivot unit.

2. The apparatus according to claim 1, wherein said disc blade includes first and second surfaces in a side surface of side surfaces of a blade tip portion of said disc blade, the side surface being located on the linear edge side at the time of cutting,
said first surface is formed from a blade tip,
said second surface inclines toward a rotation center of said disc blade with respect to the first surface and is continuous with the first surface, and
said controller controls said pivot unit so as to make an cross point between the first surface and second surface of said disc blade abut against the linear edge.

3. The apparatus according to claim 1, further comprising
a support portion which supports said driving unit so as to allow said driving unit to move in a direction of a rotation axis line of said disc blade, and
a biasing portion which biases said driving unit in a direction to approach the substrate.

4. The apparatus according to claim 1, wherein said pivot unit is placed such that a pivot center axis of said pivot unit is included in a plane parallel to a plane including said disc blade.

5. The apparatus according to claim 2, wherein said disc blade includes third and fourth surfaces in another side surface of the side surfaces of the blade tip portion of said disc blade, the another side surface being located on a side opposite to the linear edge side at the time of cutting,
said third surface is formed from the blade tip and,
said fourth surface inclines toward the rotation center of said disc blade with respect to the third surface and is continuous with the third surface.

6. The apparatus according to claim 1, wherein said driving unit comprises a rotating shaft body including an attachment portion for said disc blade at a distal end; and
a tubular body which is provided to surround a circumferential surface of said rotating shaft body and is freely rotatable with respect to said rotating shaft body.

7. The apparatus according to claim 1, wherein the substrate comprises a rectangular substrate,
said apparatus includes a first head unit and a second head unit each comprising said disc blade, said driving unit, and said pivot unit,
said moving device comprises
a first moving unit which supports said first head unit and moves said first head unit in a direction parallel to a first pair of opposing linear edges of the rectangular substrate,
a second moving unit which supports said second head unit and moves said second head unit in a direction parallel to the first pair of linear edges of the rectangular substrate, and
a third moving unit which moves said first moving unit and said second moving unit in a direction parallel to a second pair of opposing linear edges of the rectangular substrate, and
said controller performs first pivot control to make said disc blade pivot by controlling said pivot unit of said first head unit and said pivot unit of said second head unit, and performs first cutting control to cut the cover sheet along a linear edge of the rectangular substrate while moving said disc blade in a direction parallel to each linear edge of the first pair by controlling said first moving unit and said second moving unit.

8. The apparatus according to claim 7, wherein said controller performs second pivot control to make said disc blade pivot, after the first cutting control, by controlling said pivot unit of said first head unit and said pivot unit of said second head unit, and performs second cutting control to cut the cover sheet along a linear edge of the rectangular substrate, after the second pivot control, while moving said each disc blade in a direction parallel to each linear edge of second pair by controlling said third moving unit.

9. The apparatus according to claim 8, wherein said controller controls said first moving unit and said second moving unit to move said respective disc blades in opposite directions in the first cutting control and the second cutting control.

10. A cutting method for a cutting apparatus including
a disc blade which trims a cover sheet covering a substrate along a linear edge of the substrate,
a driving unit which supports the disc blade vertically with respect to a plane direction of the substrate and rotate the disc blade,
a moving device which moves one of the driving unit and the substrate so as to move the disc blade along the linear edge with respect to the substrate,
a pivot unit which pivots said disc blade about an axis perpendicular to a surface of the substrate for adjusting an angle between a plane which includes the linear edge and is perpendicular to the surface of the substrate and a plane formed by said disc blade, said pivot unit maintaining a pivot angle of said disc blade,
a support portion which supports the driving unit so as to allow the driving unit to move in a rotation axis line direction of the disc blade, and
a biasing portion which biases the driving unit in a direction to approach the substrate, the method comprising:
a first cutting step of cutting the cover sheet by causing the pivot unit to adjust the disc blade to a predetermined angle and causing the moving device to make the disc blade abut at a predetermined position on a first linear edge of the substrate and move the disc blade relative to the substrate along the first linear edge; and
a second cutting step of cutting the cover sheet, after the first cutting step, by causing the pivot unit to adjust the disc blade to a predetermined angle and causing the moving device to make the disc blade abut at a predetermined position on a second linear edge adjacent to the first linear edge and move the disc blade relative to the substrate along the second linear edge.

11. The method according to claim 10, wherein the first cutting step comprises
a first partial cutting step of cutting the cover sheet by causing the pivot unit to adjust the disc blade to a predetermined first angle and causing the moving device to make the disc blade abut at a midway portion of a first linear edge of the substrate and move the disc blade relative to the substrate in a first direction along the first linear edge, and
a second partial cutting step of cutting the cover sheet, after the first partial cutting step, by adjusting the disc blade to a predetermined second angle and causing the moving device to make the disc blade abut at the midway portion and move the disc blade relative to the substrate in a second direction opposite to the first direction along the first linear edge.

12. The method according to claim 11, wherein the second cutting step comprises
a third partial cutting step of cutting the cover sheet by causing the pivot unit to adjust the disc blade to a predetermined third angle and causing the moving device to make the disc blade abut at a midway portion of a second linear edge of the substrate and move the disc blade with respect to the substrate in a third direction along the second linear edge; and
a fourth partial cutting step of cutting the cover sheet, after the third partial cutting step, by adjusting the disc blade to a predetermined fourth angle and causing the moving device to make the disc blade abut at the midway portion and move the disc blade with respect to the substrate in a fourth direction opposite to the third direction along the second linear edge.
